(19) United States
(12) Patent Application Publication
(10) Pub. No.: US 2022/0274395 A1
(43) Pub. Date: Sep. 1, 2022

(54) DECORATIVE MEMBER MANUFACTURING APPARATUS AND METHOD FOR MANUFACTURING DECORATIVE MEMBER

(71) Applicant: FUJIFILM Corporation, Tokyo (JP)

(72) Inventor: Tomohiro MIZUNO, Ashigarakami-gun (JP)

(73) Assignee: FUJIFILM Corporation, Tokyo (JP)

(21) Appl. No.: 17/747,529

(22) Filed: May 18, 2022

Related U.S. Application Data
(63) Continuation of application No. PCT/JP2020/042786, filed on Nov. 17, 2020.

(30) Foreign Application Priority Data
Nov. 20, 2019 (JP) 2019-209334

(51) Int. Cl. B41J 2/045; B41J 2/21

(52) U.S. Cl. CPC B41J 2/0456; B41J 2/2103; B41J 2/04586

(57) ABSTRACT

Provided are a decorative member manufacturing apparatus and a method for manufacturing a decorative member which is formed in a reproduction color and has a desired tactile sensation.

In the decorative member manufacturing apparatus and the method for manufacturing a decorative member of the present invention, a fluid is jetted from a jetting part toward a base material to form a decorative layer, and fine particles constituting a surface of the decorative layer are scattered from a scattering part toward the base material. An amount of the fine particles which are scattered from the scattering part to constitute the surface of the decorative layer is an amount which corresponds to a setting content regarding a tactile sensation of the decorative member and to a jetting amount of the fluid from the jetting part during the formation of the decorative layer.

### CROSS-REFERENCE TO RELATED APPLICATIONS

This application is a Continuation of PCT International Application No. PCT/JP2020/042786 filed on Nov. 17, 2020, which claims priority under 35 U.S.C. § 119(a) to Japanese Patent Application No. 2019-209334 filed on Nov. 20, 2019. The above application is hereby expressly incorporated by reference, in its entirety, into the present application.

### BACKGROUND OF THE INVENTION

### 1. Field of the Invention

The present invention relates to a decorative member manufacturing apparatus and a method for manufacturing a decorative member, and particularly relates to a decorative member manufacturing apparatus and a method for manufacturing a decorative member, thereby manufacturing a decorative member to which a predetermined tactile sensation is imparted.

### 2. Description of the Related Art

With the recent development of printing technique, the market for decorative members manufactured using digital printing technique is expanding. For example, the decorative member can be manufactured by printing a decorative layer on a surface of a base material with ink or the like. The decorative layer develops a predetermined texture on the surface thereof. JP2016-83886A discloses an example of a decorative member manufacturing apparatus in which a decorative layer (image) having a desired texture is printed.

In the apparatus (referred to as an “image forming apparatus” in JP2016-83886A) disclosed in JP2016-83886A, ink is jetted from a print head toward the surface of the base material, and a light irradiation unit irradiates the ink landed on the surface of the base material with light to cure the ink. In this case, information on an inclination of the surface of the base material with respect to a jetting direction of the ink is acquired, and the light irradiation of the light irradiation unit is controlled based on the acquired inclination information. With such a configuration, in the apparatus disclosed in JP2016-83886A, it is possible to form a decorative layer (image) having a desired texture in consideration of a surface shape (particularly, inclination) of the base material.

### SUMMARY OF THE INVENTION

By using the apparatus disclosed in JP2016-83886A, it is possible to control an uneven shape on the surface of the decorative layer as a texture. On the other hand, as a texture, it may be required to efficiently reproduce a tactile sensation such as a frictional sensation. As a measure to meet such a demand, it is conceivable to control the tactile sensation of the surface of the decorative layer by scattering fine particles on the surface of the decorative layer (ink image) printed on the base material.

The inventors of the present invention have developed a technique for controlling the tactile sensation of the surface of the decorative layer by, after jetting photocurable ink toward the surface of the base material, irradiating the landed photocurable ink with light to be in a semi-cured state, and adhering the fine particles to the semi-cured ink dots.

On the other hand, in a case of manufacturing a decorative member, a decorative layer having a color to be reproduced and having an unevenness and the like of the surface is usually formed, but an amount of ink used at that time is determined according to the color to be reproduced, and the like. However, changes in the amount of ink used affect the tactile sensation imparted to the surface of the decorative layer. Therefore, in the scattering of the fine particles on the surface of the decorative layer to control the tactile sensation of the decorative member, in a case where the fine particles are scattered without considering the influence of the amount of ink, the desired tactile sensation may not be obtained as the tactile sensation finally imparted to the surface of the decorative layer.

The present invention has been studied in view of such circumstances, and an object of the present invention is to achieve the following objects.

To solve the above-described problems of the prior art, an object of the present invention is to provide a decorative member manufacturing apparatus and a method for manufacturing a decorative member having a desired tactile sensation.

In order to achieve the above-described objects, the decorative member manufacturing apparatus according to an aspect of the present invention is a decorative member manufacturing apparatus for manufacturing a decorative member having a decorative layer formed on a surface of a base material, the decorative member manufacturing apparatus including a jetting part which jets a fluid toward the base material to form the decorative layer and a scattering part which scatters fine particles constituting a surface of the decorative layer toward the base material, characterized in that an amount of the fine particles which are scattered from the scattering part to constitute the surface of the decorative layer is an amount which corresponds to a setting content regarding a tactile sensation of the decorative member and to a jetting amount of the fluid from the jetting part during the formation of the decorative layer.

In the decorative member manufacturing apparatus according to the aspect of the present invention, configured as described above, a scattering amount of the fine particles constituting the surface of the decorative layer is an amount which corresponds to a setting content regarding a tactile sensation of the decorative member and to a jetting amount of the fluid during the formation of the decorative layer. Accordingly, the amount of the fine particles on the surface of the decorative layer can be adjusted to an appropriate amount in consideration of influence of the jetting amount of the fluid on the tactile sensation. As a result, it is possible to manufacture a decorative member having a desired tactile sensation.

In addition, in the decorative member manufacturing apparatus according to the aspect of the present invention, it is preferable that the jetting amount of the fluid from the jetting part during the formation of the decorative layer is an amount according to a reproduction color of the decorative layer, the jetting part jets, toward the base material, a plurality of types of colored fluids having different colors from each other, a jetting amount of the colored fluids is set for each type of the colored fluids, and the amount of the fine particles which are scattered from the scattering part to constitute the surface of the decorative layer is an amount which corresponds to the setting content regarding the tactile sensation of the decorative member and to the jetting amount of the each type of the colored fluids.

In the above case, the amount of the fine particles on the surface of the decorative layer can be adjusted to an appropriate amount in consideration of influence of the type and jetting amount of the colored fluid on the tactile sensation.

In addition, in the decorative member manufacturing apparatus according to the aspect of the present invention, it is preferable that the jetting part jets a transparent fluid which is cured by receiving light to superpose the transparent fluid on the colored fluid which has landed on the base material, the scattering part scatters the fine particles to adhere the fine particles to the transparent fluid superposed on the colored fluid, the amount of the fine particles constituting the surface of the decorative layer is determined according to a jetting amount of the transparent fluid from the jetting part, and the jetting amount of the transparent fluid from the jetting part is set according to the setting content regarding the tactile sensation of the decorative member and to the jetting amount of the colored fluid.

With the above configuration, the amount of the fine particles on the surface of the decorative layer can be appropriately adjusted by adjusting the jetting amount of the transparent fluid, to which the fine particles adhere.

In addition, in the above-described configuration, it is more suitable to include a semi-curing part which semi-cures the transparent fluid by irradiating the transparent fluid superposed on the colored fluid with light, in which the scattering part scatters the fine particles to adhere the fine particles to the semi-cured transparent fluid.

In the above case, since the fine particles adhere well to the semi-cured transparent fluid, the effect of imparting a tactile sensation to the decorative member by adhering the fine particles is appropriately exhibited.

In addition, in the above-described configuration, it is still more suitable that, in a case where the surface of the decorative layer is divided into a plurality of regions, each of the jetting amount of the colored fluid and the jetting amount of the transparent fluid is set for each of the regions.

In the above case, the tactile sensation of the surface of the decorative layer can be adjusted for each region by controlling the amount of the fine particles adhering to each region on the surface of the decorative layer.

In addition, in the above-described configuration, it is even more suitable to include a reference information storage part that stores first reference information for determining a jetting amount of the colored fluid, which is required to reproduce the reproduction color of the decorative layer, from the reproduction color of the decorative layer, and second reference information for determining a jetting amount of the transparent fluid, which is required to adhere the fine particles in an amount for realizing the tactile sensation indicated by the setting content, from the setting content and the jetting amount of the colored fluid; and a condition setting part that sets the jetting amount of the colored fluid based on the first reference information, and sets the jetting amount of the transparent fluid based on the second reference information.

With the above configuration, the jetting amounts of the colored fluid and transparent fluid can be set relatively easily by referring to the first reference information and the second reference information.

In addition, in the above-described configuration, it is even still more suitable that the first reference information is a conversion table for converting a gradation value of the reproduction color of the decorative layer into the jetting amount of the colored fluid, which is required to reproduce the reproduction color of the decorative layer, and the second reference information is a conversion table for converting a value of a target tactile sensation indicated by the setting content and the jetting amount of the colored fluid into a jetting amount of the transparent fluid, which is required to adhere the fine particles in an amount for realizing the target tactile sensation indicated by the setting content.

With the above configuration, the jetting amounts of the colored fluid and transparent fluid can be set more easily by referring to the first reference information and the second reference information, which are conversion tables.

In addition, in the above-described configuration, the target tactile sensation may be a magnitude of friction on the surface of the decorative layer. In this case, the magnitude of friction on the surface of the decorative layer can be adjusted as the tactile sensation of the decorative member.

In addition, in the above-described configuration, it is more suitable that the condition setting part sets the jetting amount of the transparent fluid according to a type of the base material used during the formation of the decorative layer.

With the above configuration, the jetting amount of the transparent fluid (in other words, the amount of the fine particles adhering) can be appropriately adjusted in consideration of the jetting amount of the colored fluid and the type of the base material.

In addition, in the above-described configuration, it is more suitable that the reference information storage part stores a plurality of the second reference information, the plurality of the second reference information respectively correspond to values of the target tactile sensation, which are different from each other, and the condition setting part refers to second reference information which is selected based on the value of the target tactile sensation indicated by the setting content among the plurality of the second reference information stored in the reference information storage part.

In this case, it is still more preferable that the condition setting part refers to second reference information associated with a value of the target tactile sensation, which is closest to the value of the target tactile sensation indicated by the setting content among the plurality of the second reference information stored in the reference information storage part.

With the above configuration, it is possible to select and refer to the second reference information suitable for realizing the desired tactile sensation from the plurality of the second reference information stored in the reference information storage part.

In addition, in the above-described configuration, it is suitable that, in a case where the value of the target tactile sensation associated with each of the plurality of the second reference information stored in the reference information storage part is different from the value of the target tactile sensation indicated by the setting content, the condition setting part refers two second reference information satisfying the following requirements (1) and (2) among the plurality of the second reference information, and sets the jetting amount of the transparent fluid from the jetting part during the formation of the decorative layer according to a jetting amount derived from the two second reference information referred.

Requirement (1): a value of the target tactile sensation associated with one of two second reference information is closest to the value of the target tactile sensation indicated by the setting content in a numerical range larger than the value of the target tactile sensation indicated by the setting content.

Requirement (2): a value of the target tactile sensation associated with the other of the two second reference information is closest to the value of the target tactile sensation indicated by the setting content in a numerical range smaller than the value of the target tactile sensation indicated by the setting content.

With the above configuration, even in a case where there is no corresponding value of the target tactile sensation indicated by the setting content in the plurality of the second reference information stored in the reference information storage part, the jetting amount of the transparent fluid for realizing the target tactile sensation can be set based on a jetting amount derived from the two second reference information satisfying the above-described requirements.

In addition, in order to achieve the above-described objects, the method for manufacturing a decorative member according to an aspect of the present invention is a method for manufacturing a decorative member having a decorative layer formed on a surface of a base material, the method including jetting a fluid from a jetting part toward the surface of the base material to form the decorative layer and scattering fine particles constituting a surface of the decorative layer from a scattering part toward the base material, characterized in that an amount of the fine particles which are scattered from the scattering part to constitute the surface of the decorative layer is an amount which corresponds to a setting content regarding a tactile sensation of the decorative member and to a jetting amount of the fluid from the jetting part during the formation of the decorative layer.

According to the above method, the amount of the fine particles on the surface of the decorative layer can be adjusted to an appropriate amount in consideration of influence of the amount (jetting amount) of the fluid jetted during the formation of the decorative layer on the tactile sensation of the decorative member. As a result, it is possible to manufacture a decorative member having a desired tactile sensation.

According to the present invention, the amount of the fine particles on the surface of the decorative layer can be adjusted to an appropriate amount in consideration of influence of the amount of fluid used on the tactile sensation of the decorative member. As a result, it is possible to manufacture a decorative member having a desired tactile sensation, which cannot be realized by decorative member manufacturing apparatuses and manufacturing methods in the related art.

### BRIEF DESCRIPTION OF THE DRAWINGS

FIG. 1 is a plan view showing an example of a decorative member.

FIG. 2 is a conceptual diagram showing a configuration of a decorative member manufacturing apparatus according to an embodiment of the present invention.

FIG. 3 is a schematic diagram showing a mechanical configuration of an inkjet printer.

FIG. 4 is a diagram showing a nozzle surface of a jetting part.

FIG. 5 is an explanatory diagram of a conversion table which is second reference information.

FIG. 6 is a diagram showing a procedure for creating the conversion table which is the second reference information.

FIG. 7 is a diagram showing a flow of a method for manufacturing a decorative member according to an embodiment of the present invention.

FIG. 8 is a diagram showing a generation procedure of control data.

FIG. 9 is a diagram showing a state in which a decorative member is manufactured by an apparatus in the related art.

FIG. 10 is a diagram showing a state in which a decorative member is manufactured by the decorative member manufacturing apparatus according to the aspect of the present invention.

### DESCRIPTION OF THE PREFERRED EMBODIMENTS

Hereinafter, a decorative member manufacturing apparatus and method for manufacturing a decorative member according to an embodiment of the present invention (present embodiment) will be described in detail with reference to suitable embodiments shown in the accompanying drawings.

It should be noted that the embodiments described below are merely examples for facilitating the understanding of the present invention, and do not limit the present invention. That is, the present invention can be modified or improved from the embodiments described below without departing from the spirit of the present invention. In addition, the present invention includes an equivalent thereof.

In addition, in the present specification, “colored” includes white and black. In addition, in the present specification, “transparent” includes translucent. In addition, in the present specification, “color” is a concept which includes at least color tone and chroma saturation, and may further include lightness.

[Decorative Member]

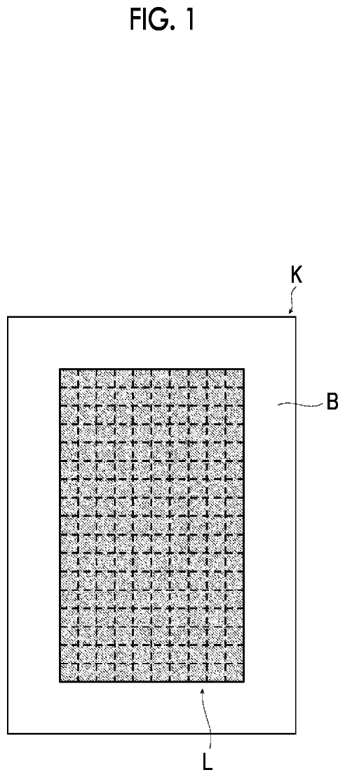

A decorative member (hereinafter, a decorative member K) according to the present embodiment will be described with reference to FIG. 1.

The decorative member K is manufactured by forming a decorative layer L on a surface of a base material B using color ink and clear ink, which are fluids, and fine particles.

The decorative layer L is formed by forming (printing) an image with the color ink, superimposing the clear ink thereon, and further adhering the fine particles to the clear ink.

The color of the decorative layer L is colored, and for example, the color of an original image (image to be printed) is reproduced.

As an example, the decorative layer L shown in FIG. 1 is formed based on an image of leather, and the color of the leather is used as a reproduction color.

In addition, a predetermined tactile sensation is imparted to the decorative member K by the decorative layer L. Here, the tactile sensation of the decorative member K is a characteristic which is expressed on a surface of the decorative member K (strictly, on the surface of the decorative member K, a portion where the decorative layer L is formed) and can be felt by a human tactile sensation (for example, hands and fingers), and for example, a magnitude of friction on the surface of the decorative layer L corresponds to this. In the decorative member K shown in FIG. 1, the tactile sensation (feeling of touch) of leather is imparted.

The tactile sensation of the decorative member K may include a tactile sensation other than the friction, for example, bendability (in other words, hardness or stretchability) of the decorative member K.

Hereinafter, materials used for manufacturing the decorative member K, that is, the color ink, the clear ink, the fine particles, and the base material will be described.

<Color Ink>

The color ink is a colored fluid containing a pigment or a dye, and is a general ink used for color printing and the like.

In the present embodiment, a plurality of types of color inks having different colors from each other are used, and for example, four color inks of C (cyan), M (magenta), Y (yellow), and K (black) are used. It is possible to reproduce any color by forming dots of these four color inks on the surface of the base material and controlling the size and density of the dots.

In the present embodiment, four color inks are used, but the present invention is not limited thereto. Three color inks of CMY may be used, or color inks of LY (light yellow) and W (white) may be added to the above-described four color inks.

<Clear Ink>

The clear ink is a colored fluid which is cured by receiving light (specifically, ultraviolet rays), that is, a photocurable ink. In addition, the fine particles adhere to a semi-cured clear ink. That is, in the present embodiment, the clear ink functions as a pressure sensitive adhesive for adhering the fine particles, and as a landing amount of the clear ink (in other words, a jetting amount) increases, an amount of the fine particles adhering increases.

A transparent fluid which can be used in the present embodiment is not limited to the clear ink, and may be any transparent fluid which can be cured by receiving light. Specifically, a composition including at least a polymerizable compound and a photoinitiator as a main component can be used, and examples thereof include a cationic polymerization type ink composition, a radical polymerization type ink composition, and an aqueous ink composition. In addition, the light to be irradiated is not limited to ultraviolet rays, may be light in a wavelength range capable of curing the transparent fluid, and may be infrared rays, visible light, and the like.

<Fine Particles>

The fine particles are substances constituting the surface of the decorative layer L, used for adjusting the tactile sensation of the decorative member K, and adhere to the clear ink in a semi-cured state. As the amount of the fine particles adhering (strictly, on the surface of the decorative layer L, an area of a portion where the fine particles are present) increases, the friction on the surface of the decorative layer L is reduced, and more specifically, a surface friction coefficient of the decorative layer L is reduced. This is because that fine particles G adhere to the surface of the decorative layer L, so that an area on the surface of the decorative layer L, which can be contacted by a human hand (finger), is reduced.

The fine particles may be granular or powdery.

In addition, a material of the fine particles is not particularly limited, and examples thereof include a polyethylene-based resin and an acrylic compound.

A friction coefficient of the fine particles of the polyethylene-based resin is 0.08 to 0.18. The polyethylene-based resin means an ethylene homopolymer or a copolymer including an ethylene monomer as a main component and the other monomer component copolymerizable with the ethylene monomer. In addition, the fact that the ethylene monomer is the main component means that the ethylene monomer occupies 50 parts by mass or more in 100 parts by mass of all the monomer components. Furthermore, the ethylene homopolymer means that the ethylene monomer occupies 92 parts by mass or more in 100 parts by mass of all the monomer components.

Examples of the polyethylene-based resin include polyethylene-based resins such as a branched low-density polyethylene, a linear low-density polyethylene, a medium-density polyethylene, a high-density polyethylene, an ethylene-propylene copolymer, and an ethylene-vinyl acetate copolymer. In order to obtain desired physical properties more easily, a linear low-density polyethylene or an ethylene-vinyl acetate copolymer is preferable as the polyethylene-based resin. In addition, the polyethylene-based resin may be used alone or in combination of two or more as long as it does not affect desired physical properties. In addition, in a case where a copolymer is used as the polyethylene-based resin, the copolymer may be a random copolymer or a block copolymer.

A friction coefficient of the fine particles consisting of the acrylic compound is approximately 0.38. The acrylic compound may be constituted of 30% by weight or more of a monomer such as acrylic acid and a salt thereof, and methacrylic acid and a salt thereof. In this case, one homopolymer or a copolymer consisting of two or more kinds of monomers may be used.

Specific examples of the acrylic acid monomer include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, neopentyl (meth)acrylate, ethylhexyl (meth)acrylate, isodecyl acrylate, lauryl (meth)acrylate, tridecyl (meth)acrylate, stearyl (meth)acrylate, benzyl (meth)acrylate, tetrahydrofurfuryl (meth)acrylate, methoxyethyl (meth)acrylate, dimethylaminoethyl (meth) acrylate, chloroethyl (meth)acrylate, trifluoroethyl (meth)acrylate, heptadecafluorooctylethyl (meth)acrylate, isobornyl (meth)acrylate, adamantyl (meth)acrylate, and tricyclodecynyl (meth)acrylate.

In addition, a copolymerization component can be introduced into the acrylic compound, and for example, a styrene-based monomer or the like can be used. In this case, a copolymerization amount can be any amount of 70 mol % or less.

In addition, in a case where a copolymer is used as the acrylic compound, the form thereof may be a block copolymer, a random copolymer, a graft copolymer, or any copolymer obtained by a combination thereof.

<Base Material>

The base material is a material which forms a base of the decorative member K. In the present embodiment, one can be selected from a plurality of types of base materials, and the decorative member K can be manufactured using the selected base material.

Examples of the types of base materials which can be used in the present embodiment include printing paper such as coated paper and non-coated paper, information paper, wrapping paper, and paper such as paperboard. In addition, examples of other types of base materials include resin film materials (for example, plastic films) and sheets. In addition, wooden, glass, ceramic, metal, or resin boards and panels can be used as the base material.

The base material consist of the papers, resin film materials, or sheets may be supplied in a state of being cut into a single sheet, or may be supplied in a state of being rolled into a roll.

Returning to the description of the decorative member K, the decorative layer L forming a surface layer of the decorative member K is formed as an image spreading in a plane (two-dimensionally), for example, as a rectangular pattern image as shown in FIG. 1. In addition, in a case where a surface of the decorative layer L on a visible side is divided into a plurality of regions, the reproduction color of each region is determined for each region. Here, the “region” is a rectangular region which is surrounded by a broken line frame in FIG. 1 and one side of which is set to a predetermined length. Specifically, the “region” is an arrangement of m×m (m is a natural number of 2 or more) of minute unit regions described later.

On the other hand, the tactile sensation on the surface of the decorative layer L, that is, the magnitude of friction is also adjusted for each region. In this case, the magnitudes of friction may be uniform between the regions, or may be different between the regions.

[Decorative Member Manufacturing Apparatus]

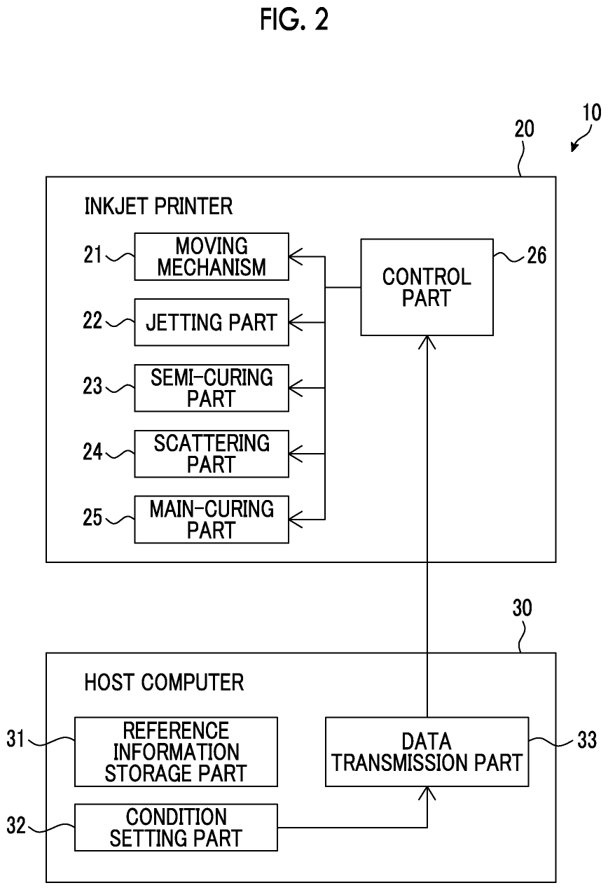

Next, a decorative member manufacturing apparatus according to the present embodiment (hereinafter, a decorative member manufacturing apparatus 10) will be described with reference to FIGS. 2 to 4.

The decorative member manufacturing apparatus 10 is a printing apparatus capable of reproducing a predetermined tactile sensation (specifically, magnitude of friction) by printing technology, and is different from the apparatus disclosed in JP2016-83886A, in which an uneven shape is formed by clear ink to impart a tactile sensation. According to the decorative member manufacturing apparatus 10, it is possible to manufacture a printed matter in which the surface tactile sensation of, for example, leather and cloth is accurately reproduced, that is, the decorative member K.

The decorative member manufacturing apparatus 10 manufactures the decorative member K using color ink, clear ink, fine particles, and a base material, and as shown in FIG. 2, includes an inkjet printer 20 and a host computer 30 as main constituent devices.

Each of the inkjet printer 20 and the host computer 30 will be described below.

<Inkjet Printer>

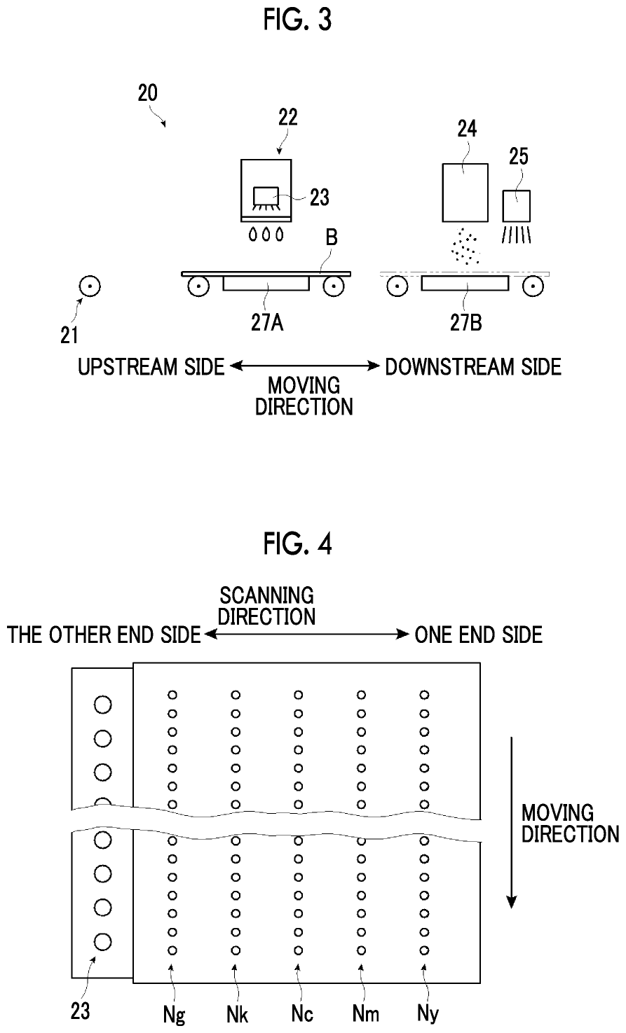

The inkjet printer 20 is an apparatus which forms the decorative layer L on the surface of the base material, and as shown in FIGS. 2 and 3, the inkjet printer 20 includes a moving mechanism 21, a jetting part 22, a semi-curing part 23, a scattering part 24, a main-curing part 25, and a control part 26.

The moving mechanism 21 causes the base material (hereinafter, referred to as the base material B) to move along a moving path in the inkjet printer 20. The moving mechanism 21 may be configured of a drive roller as shown in FIG. 2, or may be configured of a drive belt.

In addition, as shown in FIG. 3, two platens 27A and 27B are arranged on an intermediate position of the moving path of the base material B.

One platen 27A is disposed on the upstream side in the moving path of the base material B. In a case where the base material B is placed on the platen 27A, the surface (strictly, surface on a side where the decorative layer L is formed) of the base material B faces a nozzle surface provided on the lower surface of the jetting part 22.

The other platen 27B is disposed on the downstream side in the moving path of the base material B. In a case where the base material B is placed on the platen 27B, the surface of the base material B faces the scattering part 24.

In addition, in the present embodiment, the base material B is intermittently moved by the moving mechanism 21. That is, every time the base material B moves by a predetermined distance, the base material B stops, and after a certain period of time, the base material B moves again by a predetermined distance, and then the same operation is repeated.

In order to form the decorative layer on the surface of the base material B, the jetting part 22 jets the color ink toward the surface of the base material B, and also jets the clear ink to superpose the clear ink on the color ink which has landed on the surface of the base material B.

In the present embodiment, the jetting part 22 is constituted of a recording head which jets each ink by driving a piezo element, and jets the color ink and the clear ink by a shuttle scan method.

More specifically, as shown in FIG. 4, on the lower surface (nozzle surface) of the jetting part 22, a plurality of nozzles arranged in a row along the moving direction of the base material B are provided for each type of ink. In the nozzle surface shown in FIG. 4, in an order from one end side along a scanning direction of the jetting part 22, a row of yellow ink nozzles Ny, a row of magenta ink nozzles Nm, a row of cyan ink nozzles Nc, a row of black ink nozzles Nk, and a row of clear ink nozzles Ng are arranged.

The color ink jetted from the jetting part 22 lands on the minute unit region on the surface of the base material B to form dots. Here, the minute unit region is a minimum unit in a case where the region where the decorative layer L is formed is divided on the surface of the base material B, and is a rectangular region corresponding to one pixel of the original image (strictly, RGB image data) printed as the decorative layer L.

The clear ink jetted from the jetting part 22 is superposed on the color ink which has landed on the surface of the base material B to form dots. Thereafter, the formed dots of the clear ink are cured by receiving ultraviolet rays.

In the present embodiment, the clear ink is jetted to be superposed on the color ink which has landed on the surface of the base material B, but the present invention is not limited thereto. For example, ultraviolet curable color ink (an example of the colored fluid) may be used. In this case, the reproduction color is realized by the ultraviolet curable color ink, and the fine particles adhere to the color ink.

In addition, the method of jetting ink from the jetting part 22 is not limited to the method of using a piezo element. Various methods such as a thermal jet method in which ink is heated by a heating element such as a heater to generate bubbles and ink droplets are blown by the pressure can be applied.

In addition, in the present embodiment, the jetting part 22 is configured of a serial type head and prints by the shuttle scan method, but the present invention is not limited thereto. For example, the jetting part 22 may be configured of a full-line type head, and may print by a single-pass method.

In addition, in the present embodiment, both the color ink nozzle and the clear ink nozzle are formed on the same nozzle surface, but the present invention is not limited thereto. For example, the jetting part 22 may have two recording heads disposed on positions separated from each other in the moving direction of the base material B, and a color ink nozzle may be formed on the lower surface of the recording head on the upstream side and a clear ink nozzle may be formed on the lower surface of the recording head on the downstream side. Furthermore, the recording heads on which the color ink nozzles are formed may be provided separately for each ink color.

The semi-curing part 23 irradiates the dots of the clear ink superposed on the color ink with light (strictly, ultraviolet rays) to semi-cure the dots of the clear ink. That is, the semi-curing part 23 irradiates the dots of the clear ink with ultraviolet rays with an irradiation intensity at a level of semi-curing. The semi-curing is a state in which the clear ink is not completely cured but is cured to the extent that the dot shape can be maintained (that is, the flow does not spread). As the semi-curing part 23, a metal halide lamp, a high-pressure mercury lamp, an ultraviolet light emitting diode (LED), and the like can be used.

In addition, in the present embodiment, as shown in FIG. 4, the semi-curing part 23 is attached to the side of the jetting part 22. Specifically, the semi-curing part 23 is fixed to the jetting part 22 on the other end side of the clear ink nozzles Ng in the scanning direction (the side opposite to the side where the color ink nozzles are arranged in a case of viewing from the clear ink nozzles). That is, the semi-curing part 23 moves in the scanning direction together with the jetting part 22.

Then, in one scanning operation of the jetting part 22, the semi-curing part 23 irradiates the base material B with ultraviolet rays immediately after the clear ink is jetted from the clear ink nozzles Ng. As a result, the dots of the clear ink superposed on the color ink immediately receive ultraviolet rays and are semi-cured.

The present invention is not limited to the case where the semi-curing part 23 is fixed to the jetting part 22 and integrated with the jetting part 22, and the semi-curing part 23 may be separated from the jetting part 22. In addition, the disposed position of the semi-curing part 23 is not particularly limited. For example, the semi-curing part 23 may be disposed on the side end portion of the platen 27A and may irradiate the base material B with ultraviolet rays from the side of the base material B.

The scattering part 24 is disposed on the downstream side of the jetting part 22 and the semi-curing part 23, and in a case where the base material B is located directly under the scattering part 24, the scattering part 24 scatters the fine particles toward the base material B. In the present embodiment, a plurality of holes (not shown) are provided on a lower surface of the scattering part 24, and the fine particles are scattered from each hole. That is, in a case where the base material B passes through a position directly under the scattering part 24, the scattering part 24 scatters the fine particles toward the portion of the base material B facing the holes of the scattering part 24. In this case, the dots of the clear ink located directly under the scattering part 24 on the surface of the base material B are semi-cured by receiving the ultraviolet rays irradiated from the semi-curing part 23. The fine particles scattered from the scattering part 24 adhere to the dots of the clear ink in the semi-cured state.

The fine particles may be scattered alone or may be scattered together with a carrier gas or the like.

At a position on the downstream side of the scattering part 24 in the moving direction of the base material B, the main-curing part 25 irradiates the dots of the clear ink in the semi-cured state with ultraviolet rays with an irradiation intensity at a level of main-curing to main-cure the dots of the clear ink. By receiving light emitted from the main-curing part 25, the dots of the clear ink, to which the fine particles adhere, are main-cured while the fine particles are held and supported on the surface thereof.

As the main-curing part 25, a metal halide lamp, a high-pressure mercury lamp, an ultraviolet light emitting diode (LED), and the like can be used.

In addition, the disposed position of the main-curing part 25 is not particularly limited. For example, the main-curing part 25 may be disposed on the side end portion of the platen 27B and may irradiate the base material B with ultraviolet rays from the side of the base material B.

The control part 26 is a controller (control circuit) built in the inkjet printer 20, and controls each of the moving mechanism 21, the jetting part 22, the semi-curing part 23, the scattering part 24, and the main-curing part 25 through a drive circuit.

Specifically, in a case where the control part 26 receives an instruction for manufacturing a decorative member sent from the host computer 30, the control part 26 controls the moving mechanism 21 to intermittently move the base material B set at a predetermined position of the inkjet printer 20 along the moving direction.

In addition, the control part 26 controls the jetting part 22 according to print data and control data while the base material B is located directly under the jetting part 22, and the color ink and the clear ink are jetted from the jetting part 22.

The print data is data which defines information necessary for reproducing the reproduction color of the surface of the decorative layer L for each region in a case where the surface of the decorative layer L is divided into a plurality of regions, and is sent from the host computer 30 together with an instruction for manufacturing the decorative member.

Here, the “reproduction color of the surface of the decorative layer L” is a color reproduced on the surface of the formed decorative layer L, and specifically, is a color of the original image (strictly, chromaticity indicated by the RGB image data of the original image) of the decorative layer L.

In addition, the “information necessary for reproducing the reproduction color” is information that defines, in order to reproduce the reproduction color, which type of color ink is jetted at what amount and which minute unit region is landed in each region of the surface of the decorative layer L.

That is, the print data defines the jetting amount of the color ink from the jetting part 22 during the formation of the decorative layer L, and the jetting amount is an amount corresponding to the reproduction color of the decorative layer L and is set for each type (each color) of the color ink.

The control data is data which defines information necessary for realizing a tactile sensation to be imparted to the decorative member K with the above-described information for each region in a case where the surface of the decorative layer L is divided into a plurality of regions, and is sent from the host computer 30 together with the instruction for manufacturing the decorative member.

Here, the “tactile sensation to be imparted to the decorative member K” is a target tactile sensation in which the content (setting content) is set on the host computer 30 side, and specifically, is the magnitude of friction on the surface of the decorative layer L.

In addition, the “information necessary for realizing a tactile sensation” is an amount of the fine particles constituting the surface of the decorative layer L, which is necessary to realize the tactile sensation, and specifically, is the amount of the fine particles adhering to each region.

In the present embodiment, the amount of the fine particles constituting the surface of the decorative layer L is determined by the jetting amount of the clear ink from the jetting part 22. Therefore, in the present embodiment, the control data defines, for each region, the jetting amount of the clear ink, which is required to adhere the fine particles in an amount for realizing the target tactile sensation. That is, the control data of the present embodiment defines the jetting amount of the clear ink from the jetting part 22 during the formation of the decorative layer L, thereby defining the amount (adhesion amount) of the fine particles required for realizing the target tactile sensation.

However, the control data is not limited to the above-described data, and may be data which directly defines the amount (adhesion amount) of the fine particles required for realizing the target tactile sensation. In addition, the control data may be data which defines both the jetting amount of the clear ink from the jetting part 22 and the amount of the fine particles scattered from the scattering part 24.

The jetting part 22 jets color inks of each color from the nozzles Ny, Nm, Nc, and Nk toward the surface of the base material B under the control of the control part 26 while moving in the scanning direction. In this case, the control part 26 controls the jetting part 22 according to the print data, so that the color ink is jetted image-wise to the surface of the base material B. As a result, on the surface of the base material B, the amount of the color ink defined by the print data lands on the portion facing the nozzles Ny, Nm, Nc, and Nk, so that a color ink image (printed image) is printed on the surface of the base material B, and in each region of the image, the color of the portion corresponding to each region in the original image is reproduced.

In addition, the jetting part 22 jets the clear inks from the clear ink nozzles Ng after jetting the color inks in one ink jetting step. In this case, the control part 26 controls the jetting part 22 according to the control data, so that the clear ink is jetted image-wise to the surface of the base material B. As a result, the amount of the clear ink defined by the control data lands on the color ink image to superpose the clear ink on the color ink image, and in each region of the color ink image, the dots of the clear ink in the amount defined by the control data are formed.

In addition, the control part 26 controls the semi-curing part 23 to irradiate ultraviolet rays from the semi-curing part 23, immediately after the clear ink is jetted from the jetting part 22. As a result, the dots of the clear ink, which have landed on the surface of the base material, are immediately semi-cured.

Thereafter, the moving mechanism 21 moves the base material B further downstream, and in a case where the base material B passes through the position directly under the scattering part 24, the control part 26 controls the scattering part 24. Under such control, the scattering part 24 scatters the fine particles toward the base material B located directly under the scattering part 24. The scattered fine particles adhere to the dots of the clear ink in the semi-cured state. In this case, the amount of the fine particles adhering to each region on the surface of the decorative layer L is determined according to the dots of the clear ink existing in each region, in other words, the jetting amount of the clear ink to each region. The tactile sensation (specifically, the magnitude of friction) is imparted to each region on the surface of the decorative layer L according to the amount of the fine particles adhering to each region.

After the base material B has passed directly under the scattering part 24, the control part 26 controls the main-curing part 25 to irradiate ultraviolet rays from the main-curing part 25. As a result, the dots of the clear ink in the semi-cured state are main-cured while the fine particles are held and supported.

As described above, the operation of each part of the inkjet printer 20, that is, the moving operation of the base material B by the moving mechanism 21, the jetting operation of the color ink and the clear ink by the jetting part 22, the semi-curing operation of the clear ink by the semi-curing part 23, the scattering operation of the fine particles by the scattering part 24, and the main-curing operation of the clear ink by the main-curing part 25 are performed under the control of the control part 26.

In a case where the above-described series of steps are completed, the decorative layer L is formed on the surface of the base material B to complete the decorative member K.

The completed decorative member K moves to a discharge port (not shown) of the inkjet printer 20 by the moving mechanism 21, and is finally discharged from the discharge port.

<Host Computer>

The host computer 30 is communicably connected to the inkjet printer 20, and executes a program such as an application program for manufacturing a decorative member and a printer driver. The printer driver generates the above-described print data from the RGB image data of the original image generated by the application program for manufacturing a decorative member.

In addition, the printer driver generates the above-described control data based on the generated print data and the setting content regarding the tactile sensation of the decorative member K. The setting content regarding the tactile sensation is a value of the target tactile sensation of the decorative member K set by a user of the decorative member manufacturing apparatus 10 (hereinafter, referred to as a “user”), and for example, is the magnitude of friction on the surface of the decorative layer L and more specifically the surface friction coefficient.

The printer driver and the application program for manufacturing a decorative member may be recorded on a recording medium, such as an optical disk, which can be read by the host computer 30, or may be downloadable to the host computer 30 through a communication network such as Internet.

As shown in FIG. 2, the host computer 30 includes a reference information storage part 31, a condition setting part 32, and a data transmission part 33. The reference information storage part 31 is composed of a memory of the host computer 30, an auxiliary storage device, and the like. The condition setting part 32 and the data transmission part 33 are composed such that a processor, a memory, a communication interface, and the like of the host computer 30 cooperate with the printer driver and the application program for manufacturing a decorative member.

The reference information storage part 31 stores information referred in a case where the print data and the control data are generated. Specifically, first reference information necessary for generating the print data and second reference information necessary for generating the control data are stored in the reference information storage part 31.

The first reference information is information for determining the jetting amount of the colored fluid (hereinafter, referred to as a required color ink amount), which is required to reproduce the reproduction color of the decorative layer L, from the reproduction color of the decorative layer L. More specifically, a conversion table for converting a gradation value regarding the reproduction color into the required color ink amount for each of the four YMCK colors is stored in the reference information storage part 31 as the first reference information. The above-described conversion table corresponds to a known color conversion look-up table used for general image printing.

The second reference information is information for determining a required clear ink amount from the setting content regarding the tactile sensation of the decorative member K and the jetting amount of the color ink defined in the print data. Here, the required clear ink amount is a jetting amount of the clear ink, which is required to adhere the fine particles in an amount for realizing the target tactile sensation (specifically, the magnitude of friction) indicated by the above-described setting content.

Explaining the second reference information in detail, a conversion table (look-up table) for converting the surface friction coefficient as the value of the target tactile sensation indicated by the setting content and the required color ink amount for each of the four YMCK colors into the required clear ink amount is stored in the reference information storage part 31 as the second reference information.

Hereinafter, the conversion table as the second reference information will be referred to as a “tactile sensation conversion table” in order to distinguish it from the conversion table as the first reference information.

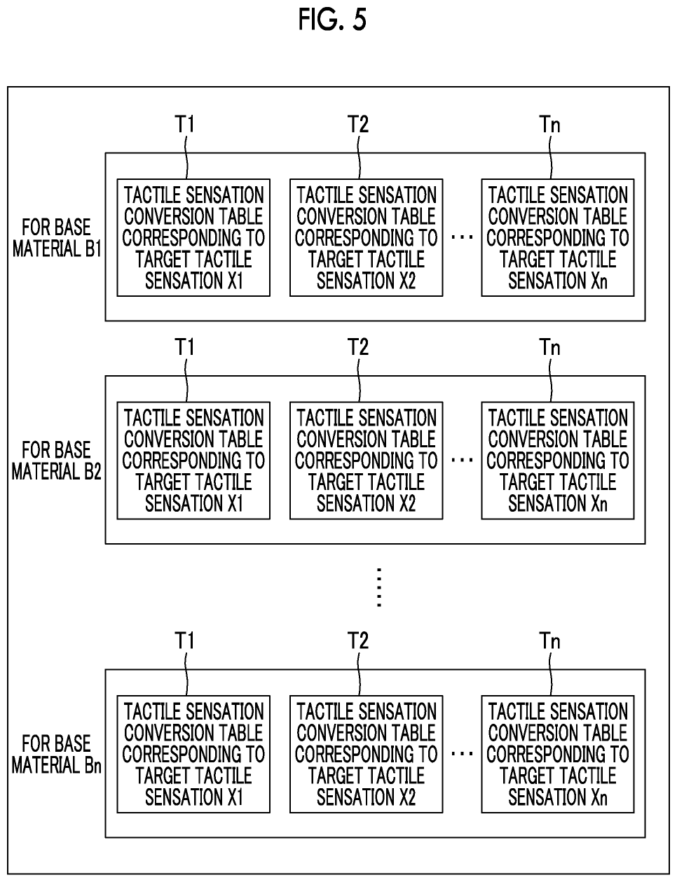

In the present embodiment, as shown in FIG. 5, a plurality of tactile sensation conversion tables are prepared, in other words, the reference information storage part 31 stores a plurality of second reference information. FIG. 5 is a diagram showing an example of the tactile sensation conversion tables.

Each of the plurality of tactile sensation conversion tables (T1 to Tn in FIG. 5) is associated with the values of the target tactile sensation, which are different from each other, specifically, with the surface friction coefficients. The value of the target tactile sensation associated with each tactile sensation conversion table is a value of the target tactile sensation realized in a case where the amount of the clear ink determined from the tactile sensation conversion table is jetted. For example, in the tactile sensation conversion tables shown in FIG. 5, in a case where the amount of the clear ink determined from a tactile sensation conversion table T1 is jetted, a target tactile sensation Xl can be realized.

In addition, in the present embodiment, as shown in FIG. 5, a plurality of tactile sensation conversion tables T1 to Tn are prepared for each of the plurality of types of the base materials B (in FIG. 5, base materials B1 to Bn) which can be used for manufacturing the decorative member. Therefore, in a case of referring to the tactile sensation conversion table, the plurality of tactile sensation conversion tables T1 to Tn corresponding to the types of base materials B actually used for manufacturing the decorative member are selected, and the selected table is referred to.

The condition setting part 32 sets conditions in a case where the control part 26 controls each part of the inkjet printer 20, and generates print data and control data by reflecting the set conditions.

More specifically, the condition setting part 32 acquires the gradation value regarding the reproduction color of the decorative layer L and refers to the conversion table as the first reference information, which is stored in the reference information storage part 31. Thereafter, the condition setting part 32 sets the required color ink amount for each of the four YMCK colors based on the conversion table referred. Then, the condition setting part 32 sets, for each region, a required color ink amount of each color for each region on the surface of the decorative layer L, and generates print data which defines the required color ink amount of each color for each region.

In addition, the condition setting part 32 recognizes the target tactile sensation indicated by the setting content regarding the tactile sensation, refers to the tactile sensation conversion table as the second reference information, which is stored in the reference information storage part 31, and set the required clear ink amount based on the tactile sensation conversion table referred. Then, the condition setting part 32 sets, for each region, the required clear ink amount for each region on the surface of the decorative layer L, and generates control data which defines the required clear ink amount for each region.

The data transmission part 33 transmits the print data and the control data generated by the condition setting part 32 to the inkjet printer 20 together with the instruction for manufacturing a decorative member.

[Procedure for Creating Tactile Sensation Conversion Table]

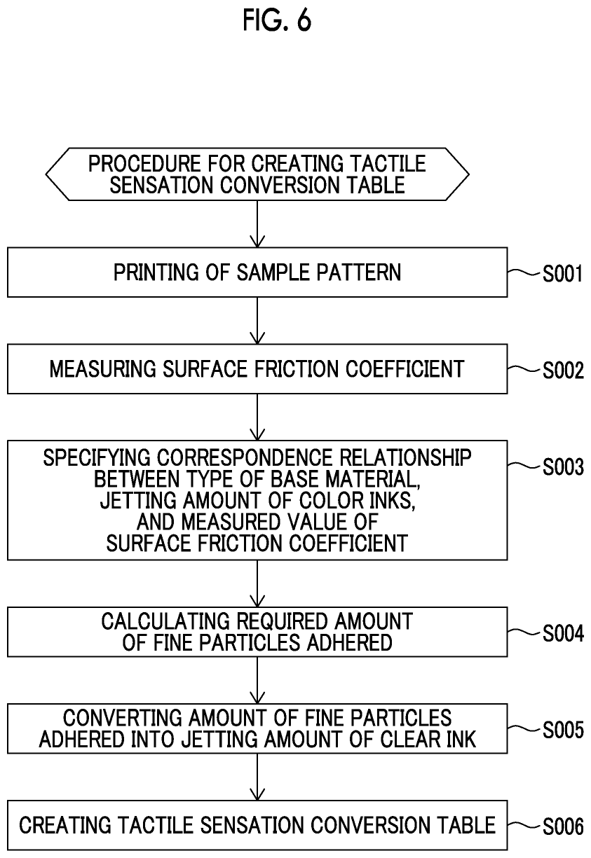

Next, a procedure for creating the tactile sensation conversion table described above will be described with reference to FIG. 6.

To create the tactile sensation conversion table, first, the base material B used for manufacturing the decorative member K is prepared, and a sample pattern is printed on the surface of the prepared base material B using the decorative member manufacturing apparatus 10 (S001). The sample pattern is a colored pattern formed by YMCK four-color inks.

In the step S001, a plurality of sample patterns are printed by changing a combination of printing densities (in other words, jetting amounts) of the YMCK four-color inks. In addition, the step S001 is performed a plurality of times by changing the types of the base materials B.

Next, for each of the plurality of sample patterns printed on the plurality of types of the base materials B, the magnitude of friction on the surface of the sample pattern, more specifically, the surface friction coefficient is measured (S002).

For the measurement of the surface friction coefficient, a known measuring instrument, for example, a friction tester (KES-SE) manufactured by KATO TECH CO., LTD. can be used. As the measurement conditions using the instrument, it is preferable that a standard friction block bar is used, a silicon sensor (10 mm×10 mm×3 mm) manufactured by KATO TECH CO., LTD. is used for the friction block, a load in a case of friction is set to 0.245 N/cm² (25 gf/cm²), and a measurement sensitivity is set to be H (sensitivity: 20 g/V). It is preferable that other conditions including friction distance, friction speed, and the like are as specified in the instrument specifications (for example, the friction distance is set to 30 mm, the analysis distance is set to 20 mm, and the sample moving speed is set to 1 mm/sec, and the like). Then, a data logger (multi-input data acquisition system manufactured by KEYENCE CORPORATION) is connected to the friction tester, the voltage value of the load obtained at the measurement is acquired, and the friction coefficient is defined as a voltage value immediately before a timing at which the friction block starts to move.

It is preferable that the measurement is performed 5 times or more in an environment of 20° C. and 65% relative humidity (RH), and the average value of the 5 times measurement is adopted.

Next, a correspondence relationship between the type of the base material B, the jetting amount of each of the YMCK four-color inks, and the surface friction coefficient measured in the step S002 is specified (S003).

Next, the amount of the fine particles adhering to set the tactile sensation on the surface of each sample pattern as the target tactile sensation (specifically, the target surface friction coefficient) is calculated from the measured value of the surface friction coefficient of each sample pattern (S004). Thereafter, the calculated amount of the fine particles adhering is converted into the jetting amount of the clear ink required to adhere the fine particles (S005). In a case of performing the step S005, a correlation between the amount of the fine particles adhering and the jetting amount of the clear ink is specified in advance, and an expression (conversion expression) representing the correlation is obtained. In the step S005, it is sufficient that the obtained conversion expression is used.

Thereafter, based on the correspondence relationship specified in the step S003 and the amount of the clear ink obtained in the step S005, a tactile sensation conversion table which defines a correspondence relationship between the jetting amount of the color inks of each color, the target tactile sensation, and the required clear ink amount is created (S006). In the step S006, a plurality of tactile sensation conversion tables are created by changing the surface friction coefficient, which is the target tactile sensation, and a table group consisting of the plurality of tactile sensation tables is created for each of the plurality of types of the base materials B used for printing the sample pattern.

[Operation Example of Decorative Member Manufacturing Apparatus]

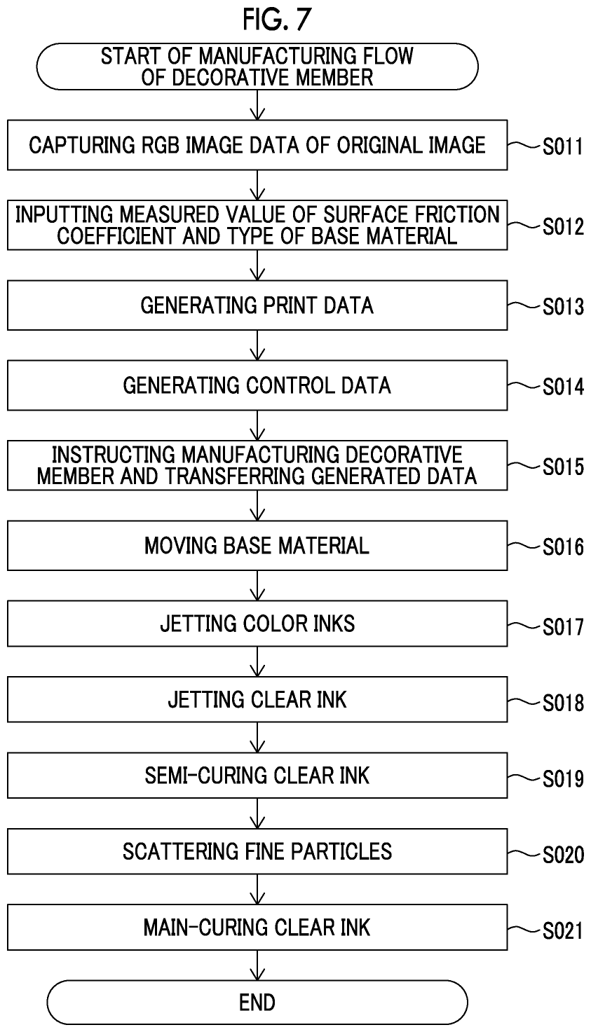

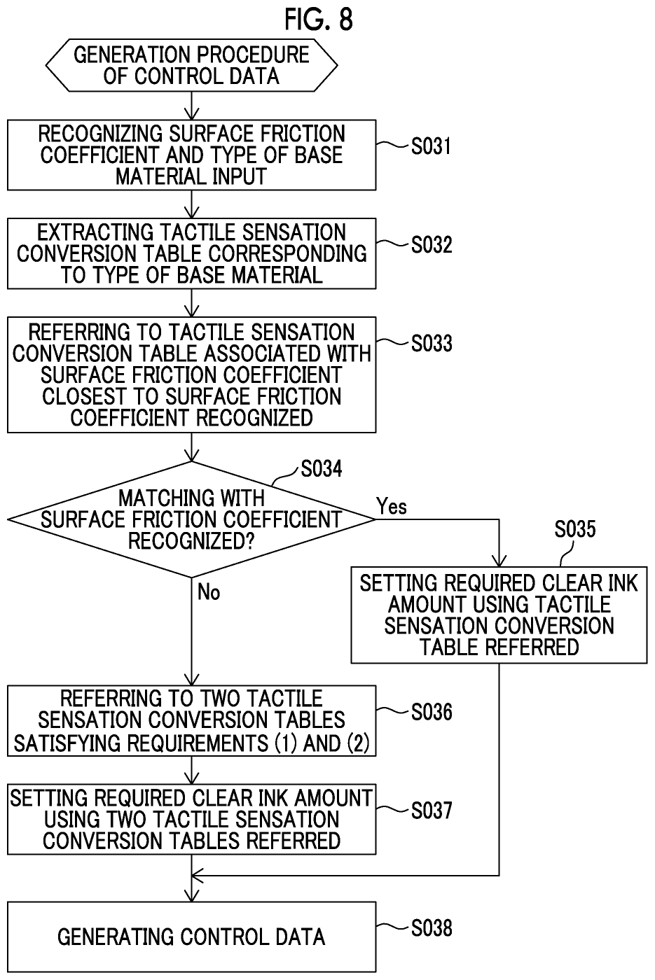

Next, as an operation example of the decorative member manufacturing apparatus 10, a manufacturing flow of the decorative member will be described with reference to FIGS. 7 and 8.

At the start of the manufacturing flow of the decorative member, the RGB image data of the original image of the decorative layer L is acquired, and the magnitude of friction (specifically, the surface friction coefficient) as the tactile sensation imparted to the surface of the decorative layer L is measured. Explaining with a specific example, in a case of manufacturing the decorative member K which imitates leather, the RGB image data of a pattern image of leather pattern is acquired, and the surface friction coefficient of the leather surface is measured using a friction tester (KES-SE) manufactured by KATO TECH CO., LTD., and the like.

In addition, in a case of starting the manufacturing flow of the decorative member, a base material B actually used as a base material for the decorative member K is prepared, and the type of the base material B is specified. Thereafter, in a case where the user starts the application program for manufacturing a decorative member on the host computer 30, the manufacturing flow of the decorative member starts. In this flow, first, the user captures the RGB image data of the acquired original image of the decorative layer L (S011).

In addition, the user inputs the measured surface friction coefficient and the specified type of the base material B through an input device such as a keyboard (S012). The surface friction coefficient input in the step S012 corresponds to the setting content regarding the tactile sensation of the decorative member K, and more specifically, corresponds to the value of the target tactile sensation indicated by the setting content.

Next, the condition setting part 32 receives the RGB image data captured in the step S011 and generates print data from the RGB image data (S013). In the step S013, the condition setting part 32 sets the required color ink amount (jetting amount) of each of the YMCK four-color inks according to the chromaticity indicated by the above-described RGB image data, that is, the reproduction color of the decorative layer L. In this case, the condition setting part 32 sets the required color ink amount for each ink color for each region in a case where the surface of the decorative layer L is divided into a plurality of regions.

More specifically, the condition setting part 32 generates the print data by executing resolution conversion processing, color conversion processing, halftone processing, and rasterization processing on the received RGB image data.

The resolution conversion processing is a process of converting the image data into a resolution reproducible by the inkjet printer 20, and specifically, converting the received RGB image data into data showing each gradation value (specifically, a value of 0 to 255) of red (R), green (G), and blue (B).

In the color conversion processing, the colors indicated by the resolution-converted RGB image data (that is, RGB tri-color) are converted into colors of ink which can be jetted by the inkjet printer 20 (that is, YMCK four-color). In this case, the condition setting part 32 refers to the conversion table (color conversion look-up table) as the first reference information stored in the reference information storage part 31.

The halftone processing is a process of converting the YMCK image data converted to gradation values of each YMCK color by the color conversion processing into color ink dot size data (in other words, jetting amount) formed on each pixel.

The rasterization processing is a process of dividing the halftone-processed YMCK image data into pixel units, and rearranging the pixel units in the order in which the pixel units are transferred to the inkjet printer 20.

By executing the above-described series of processes, the required color ink amount for each ink color for each region on the surface of the decorative layer L is determined. The condition setting part 32 generates the print data in which the determined required color ink amount is defined for each region.

In the present embodiment, by referring to the conversion table (color conversion look-up table) as the first reference information, the required color ink amount can be easily and quickly determined.

Next, the condition setting part 32 generates control data based on the surface friction coefficient and type of the base material B input in the step S012, and the required color ink amount of each color indicated by the print data generated in the step S013 (S014).

In the step S014, the condition setting part 32 sets the required clear ink amount (jetting amount) according to the surface friction coefficient as the value of the target tactile sensation, the required color ink amount of each color, and the type of the base material B. In this case, the condition setting part 32 sets the required clear ink amount for each region in a case where the surface of the decorative layer L is divided into a plurality of regions.

More specifically, the condition setting part 32 recognizes the surface friction coefficient and type of the base material B input in the step S012 (S031), and extracts a tactile sensation conversion table corresponding to the recognized type of the base material B from the tactile sensation conversion table group as the second reference information stored for each type of the base materials B in the reference information storage part 31 (S032). In this case, a plurality of tactile sensation conversion tables associated with a plurality of target tactile sensation values (specifically, surface friction coefficients) different from each other are extracted.

Thereafter, in the plurality of tactile sensation conversion tables extracted in the step S032, the condition setting part 32 refers to a tactile sensation conversion table selected based on the surface friction coefficient (that is, the value of the target tactile sensation indicated by the setting content regarding the tactile sensation) recognized in the step S031.

More specifically, in the plurality of tactile sensation conversion tables extracted in the step S032, the condition setting part 32 refers to a tactile sensation conversion table associated with a surface friction coefficient closest to the surface friction coefficient recognized in the step S031 (S033). Thereafter, the condition setting part 32 determines whether the surface friction coefficient associated with the tactile sensation conversion table referred matches the surface friction coefficient recognized in the step S031 (S034).

In a case where it is determined in the step S034 that both surface friction coefficients match, the condition setting part 32 sets the required clear ink amount for each region on the surface of the decorative layer L by using the tactile sensation conversion table referred in the step S003 (S035). In this case, the condition setting part 32 sets the required clear ink amount from the required color ink amount of each color defined in the print data generated in the step S014 based on the tactile sensation conversion table referred. Specifically, in a plurality of columns in the tactile sensation conversion table, a column corresponding to the required color ink amount of each color is specified, and the jetting amount of the clear ink stored in the specified column is set as the required clear ink amount.

On the other hand, the condition setting part 32 may determine that both surface friction coefficients are different from each other in the step S034, but this is a situation in which the value of the target tactile sensation associated with each of the plurality of tactile sensation conversion tables stored in the reference information storage part 31 is different from the value of the target tactile sensation indicated by the setting content regarding the tactile sensation. In this case, the condition setting part 32 refers to two tactile sensation conversion tables which satisfy the following requirements (1) and (2) among the plurality of tactile sensation conversion tables extracted in the step S032 (S036).

Requirement (1): a surface friction coefficient associated with one of two tactile sensation conversion tables is closest to the surface friction coefficient indicated by the setting content of the user in a numerical range larger than the surface friction coefficient indicated by the setting content of the user.
Requirement (2): a surface friction coefficient associated with the other of the two tactile sensation conversion tables is closest to the surface friction coefficient indicated by the setting content of the user in a numerical range smaller than the surface friction coefficient indicated by the setting content of the user.

Then, the condition setting part 32 sets the required clear ink amount from the required color ink amount of each color defined in the print data generated in the step S014 based on the two tactile sensation conversion tables referred in the step S036 (S037). Specifically, each of the two tactile sensation conversion tables is referred, and in a plurality of columns in each tactile sensation conversion table, a column corresponding to the required color ink amount of each color is specified, and the jetting amount of the clear ink stored in the specified column is derived. Thereafter, the condition setting part 32 sets the required clear ink amount to be actually adopted by interpolating with the jetting amount of the clear ink determined from each of the two tactile sensation conversion tables.

In the present embodiment, the required clear ink amount is set by interpolating with the jetting amount of the clear ink determined from each of the two tactile sensation conversion tables, but the tactile sensation conversion tables used for interpolation are not limited to two, and may be three or more. In this case, it is preferable to include at least two tactile sensation conversion tables satisfying the above-described requirement (1) and (2).

As described above, in the present embodiment, by referring to the tactile sensation conversion table as the second reference information, the jetting amount of the clear ink required for reproducing the desired tactile sensation can be easily and quickly determined.

Through the series of steps S031 to S037, the required clear ink amount for each region on the surface of the decorative layer L is determined according to the value of the target tactile sensation (specifically, the surface friction coefficient) indicated by the setting content regarding the tactile sensation and the required color ink amount (jetting amount) of each color. The condition setting part 32 generates the control data in which the determined required clear ink amount is defined for each region (S038).

Returning to the description of the manufacturing flow of the decorative member, after the print data and the control data are generated, the data transmission part 33 transmits these data to the inkjet printer 20 together with the instruction for manufacturing a decorative member (S015).

In a case of receiving the instruction for manufacturing a decorative member, the control part 26 of the inkjet printer 20 controls each part of the inkjet printer 20 in order to form the decorative layer L on the surface of the base material B. Specifically, the control part 26 controls the moving mechanism 21 to move the base material B charged in the inkjet printer 20 along the moving path (S016). In addition, in a case where the base material B passes directly under the jetting part 22, the control part 26 controls the jetting part 22 according to the print data, and the jetting part 22 jets color inks of each color toward the surface of the base material B (S017). The jetting amount of the color inks of each color in this case is the required color ink amount specified in the print data, that is, the amount corresponding to the reproduction color of the decorative layer L, and it is set for each region in a case where the surface of the decorative layer L is divided into a plurality of regions.

The color inks landed on the surface of the base material B form a color ink image consisting of ink dots, and in each portion of the color ink image, the color of the original image of the decorative layer L is reproduced as the reproduction color of the decorative layer L. Since the jetting amount of the color inks of each color is set for each region on the surface of the decorative layer L, the color of each portion of the color ink image, in other words, the color of each region on the surface of the decorative layer L is adjusted image-wise for each region.

In addition, under the control of the control part 26, the jetting part 22 jets the clear ink to superpose on the color inks landed on the surface of the base material B (S018). In this case, the control part 26 controls the jetting part 22 according to the control data. As a result, an amount of the clear ink corresponding to the required clear ink amount defined in the control data is jetted from the jetting part 22. The jetting amount of the clear ink in this case is an amount corresponding to the value of the target tactile sensation (specifically, the surface friction coefficient) indicated by the setting content regarding the tactile sensation and the jetting amount of the color inks of each color from the jetting part 22, and it is set for each region in a case where the surface of the decorative layer L is divided into a plurality of regions.

After landing on the color ink image superposed, the clear ink jetted from the jetting part 22 is quickly semi-cured by ultraviolet rays emitted from the semi-curing part 23 (S019). Thereafter, the moving mechanism 21 moves the base material B further downstream, and in a case where the base material B passes through the position directly under the scattering part 24, the control part 26 controls the scattering part 24, and the scattering part 24 scatters the fine particles toward the base material B (S020). In the case, the amount of the fine particles scattered is defined by, for example, the control data, and may be individually adjusted for each region on the surface of the decorative layer L, or may be uniform between the regions.

The fine particles scattered at a position directly above the base material B adhere to the surface of the clear ink in a semi-cured state, and form the surface of the decorative layer L. In this case, the amount of the fine particles adhering to each region is determined according to the amount of the clear ink landed on each region, in other words, the jetting amount of the clear ink to each region. In other words, it can be said that the amount of the fine particles which are scattered from the scattering part 24 to constitute the surface of the decorative layer L is an amount corresponding to the value of the target tactile sensation (the surface friction coefficient) indicated by the setting content regarding the tactile sensation and the jetting amount of the color inks of each color from the jetting part 22.

By adhering the fine particles to the surface of the clear ink, on the surface of the decorative layer L, the target tactile sensation, specifically the surface friction, is adjusted according to the amount of the fine particles adhering, and the value is the value of the target tactile sensation indicated by the setting content regarding the tactile sensation, specifically, the surface friction coefficient input in the step S012.

Since the jetting amount of the clear ink is set for each region on the surface of the decorative layer L, the amount of the fine particles (adhesion amount) constituting each region on the surface of the decorative layer L is adjusted image-wise for each region.

Thereafter, the moving mechanism 21 moves the base material B further downstream, and in a case where the base material B passes through the position directly under the main-curing part 25, the control part 26 controls the main-curing part 25, and the main-curing part 25 irradiates the clear ink in a semi-cured state with ultraviolet rays. As a result, the clear ink in a semi-cured state is main-cured with the fine particles held and supported on the surface (S021).

In a case where the series of treatments up to the above is completed, the decorative layer L is formed on the surface of the base material B to complete the decorative member K. The completed decorative member K moves to a discharge port (not shown) by the moving mechanism 21, and is discharged from the discharge port to the outside of the inkjet printer 20. In a case where the decorative member K is discharged, the manufacturing flow of the decorative member ends.

[Regarding Effects of Present Invention]

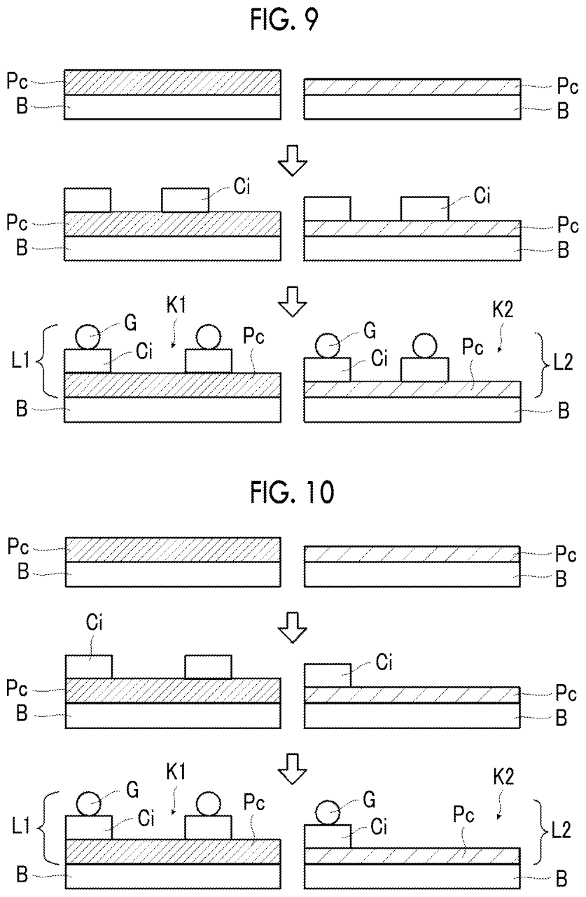

As described above, in the present embodiment, the jetting amount of the color ink from the jetting part 22 during the formation of the decorative layer L is set according to the reproduction color of the decorative layer L. In addition, the amount the fine particles which are scattered from the scattering part 24 to constitute the surface of the decorative layer L is determined according to the jetting amount of the clear ink on the color ink, and the jetting amount of the clear ink is set according to the setting content regarding the tactile sensation of the decorative member K and the jetting amount of the color ink. As a result, it is possible to reproduce the tactile sensation to be imparted to the decorative member K with high accuracy. Such an effect will be specifically described with reference to FIGS. 9 and 10.

Each of FIGS. 9 and 10 shows manufacturing process of two types of decorative members K1 and K2, and a decorative layer L1 of the decorative member K1 (shown on the left side of each figure) is formed based on an RGB image data of a first image, and a decorative layer L2 of the decorative member K2 (shown on the right side of each figure) is formed based on an RGB image data of a second image. Here, the first image and the second image are images having different colors from each other, and the first image is an image having a darker color and the second image is an image having a lighter color. In addition, the same value of the target tactile sensation (specifically, the surface friction coefficient) is set for both of the above two types of decorative members K1 and K2.

A procedure for manufacturing the decorative member K by a manufacturing apparatus in the related art is generally the same as the above-described manufacturing flow of the decorative member, and as shown in FIG. 9, color inks of each color are jetted by jetting amounts set according to a reproduction color of the decorative layer and are landed on the surface of the base material B to form a color ink image Pc, a clear ink Ci is jetted to be superposed on the color ink image Pc, and fine particles G are adhering to the clear ink Ci to form the decorative layers L1 and L2.

Here, in the manufacturing apparatus in the related art, the jetting amount of the clear ink Ci, in other words, the amount of the fine particles G adhering is set based on the setting content regarding the tactile sensation, specifically, the surface friction coefficient which is the value of the target tactile sensation. Therefore, in a case where the same surface friction coefficient is set for each of the two types of decorative members K1 and K2, as shown in FIG. 9, the same amount of the clear ink Ci is jetted in forming the decorative layers L1 and L2 of the respective decorative members K1 and K2, and as a result, the same amount of the fine particles G adheres.

However, even in a case where the amount of the fine particles G adhering is the same, since the landing amounts of the color inks of each color for forming the decorative layers L1 and L2 are different from each other in a case where the reproduction colors of the decorative layers L1 and L2 are different from each other, the surface tactile sensation of the decorative layers L1 and L2 changes due to this, and understandably, the surface friction coefficient of each of the decorative layers L1 and L2 also changes. For example, in a case where the amount of the fine particles adhering between the decorative layers L1 and L2 is the same, the surface friction coefficient of the decorative layer L1 which is formed in a darker color is the same as the surface friction coefficient of the decorative layer L2 which is formed in a lighter color. This is because the darker-colored decorative layer L1 has a larger landing amount of the color ink than the lighter-colored decorative layer L2, so that an ink surface is smoother, or a covering rate for the base material B having a low friction coefficient, such as paper, is higher. That is, since the darker-colored decorative layer L1 has a surface friction coefficient than the lighter-colored decorative layer L2, even in a case where the same amount of the fine particles G are adhering, the surface friction coefficient of the decorative layer L1 is different from the surface friction coefficient of the decorative layer L2.

As described above, in the decorative member manufactured by the apparatus in the related art, since the reproduction color of the decorative layer is not taken into consideration, the set target tactile sensation may not be reproduced accurately.

On the other hand, in the decorative member manufacturing apparatus according to the embodiment of the present invention (that is, the above-described decorative member manufacturing apparatus 10), the jetting amount of the clear ink Ci and the amount of the fine particles adhering are determined according to the set values of the target tactile sensation (surface friction coefficient) and the jetting amounts of the color inks of each color during the formation of the decorative layers L1 and L2. That is, in the present invention, in consideration of the jetting amounts of the color inks of each color during the formation of the decorative layers L1 and L2, the amount of the fine particles G adhering required for reproducing the set target tactile sensation, strictly, the jetting amount of the clear ink Ci required for securing the adhesion amount is derived. As a result, as shown in FIG. 10, the amounts of the fine particles G constituting the decorative layers L1 and L2 having different reproduction colors are adjusted according to each reproduction color. As a result, both of the surface friction coefficients of the two types of decorative layers L1 and L2 having different reproduction colors are adjusted to be equal to the surface friction coefficient set as the value of the target tactile sensation.

As described above, according to the decorative member manufacturing apparatus according to the embodiment of the present invention, it is possible to manufacture the decorative member K in which the reproduction color is well reproduced and the tactile sensation as set is realized.

### Other Embodiments

The decorative member manufacturing apparatus and method for manufacturing a decorative member according to the embodiment of the present invention have been described above with a specific embodiment, but the above-described embodiment is merely an example and other embodiments are also conceivable.

For example, in the above-described embodiment, the decorative member manufacturing apparatus 10 is configured by the inkjet printer 20 and the host computer 30, the inkjet printer 20 and the host computer 30 are separated from each other as separate devices. However, the present invention is not limited thereto, and a unit corresponding to the inkjet printer 20 and a unit corresponding to the host computer 30 may be housed in the same housing and integrated as one apparatus.

In addition, in the above-described embodiment, in a case of determining the required clear ink amount, in other words, the amount of the fine particles constituting the surface of the decorative layer L, the tactile sensation conversion table (look-up table) is referred to as the second information. In this case, the required clear ink amount can be easily and quickly obtained, but the present invention is not limited thereto. For example, a correlation between the jetting amounts of the color ink of each color and the clear ink during the formation of the decorative layer L, the amount of the fine particles adhering, and the value of the tactile sensation (specifically, the surface friction coefficient) imparted to the surface of the decorative layer L may be specified by a calculation process, and the required clear ink amount may be obtained based on an expression representing the specified correlation. In this case, in the above-described calculation process, the reproduction color is determined by the calculation in the printer driver, and the jetting amount of the color ink is obtained from ink amount information per unit area (ink dot size×number of dots). Then, regarding the tactile sensation value, a correlation in a case where the jetting amount of the color ink and the jetting amount of the clear ink are each changed is specified by a predetermined calculation method.

In addition, in the above-described embodiment, the jetting amount of the color ink during the formation of the decorative layer is determined according to the reproduction color of the decorative layer. In addition, the amounts of the fine particles G and the clear ink Ci, which are used to reproduce the target tactile sensation (specifically, the target value of the surface friction coefficient) of the decorative layer, are determined according to the jetting amount of the color ink during the formation of the decorative layer. That is, in the above-described embodiment, in a case where the color ink is jetted in order to realize the reproduction color, since the tactile sensation of the decorative layer changes due to this, the tactile sensation of the decorative layer is adjusted by the fine particles G and the clear ink Ci.

On the other hand, it is conceivable to use both color ink and clear ink to form a decorative layer having unevenness on the surface. In this case, it is sufficient that the amounts of the fine particles and the clear ink are determined according to the jetting amounts of the color ink and the clear ink, which are used to reproduce unevenness degree. As a result, it is possible to manufacture a decorative member in which the unevenness to be reproduced is well reproduced and the tactile sensation as set is realized.

### EXPLANATION OF REFERENCES

10: decorative member manufacturing apparatus
20: inkjet printer
21: moving mechanism
22: jetting part
23: semi-curing part
24: scattering part
25: main-curing part
26: control part
27A, 27B: platen
30: host computer
31: reference information storage part
32: condition setting part
33: data transmission part
B: base material
Ci: clear ink
G: fine particle
K, K1, K2: decorative member
L, L1, L2: decorative layer
Pc: color ink image
T1, T2, Tn: tactile sensation conversion table (conversion table)

What is claimed is:

1. A decorative member manufacturing apparatus for manufacturing a decorative member having a decorative layer formed on a surface of a base material, the decorative member manufacturing apparatus comprising:
a jetting part which jets a fluid toward the base material to form the decorative layer; and
a scattering part which scatters fine particles constituting a surface of the decorative layer toward the base material,
wherein an amount of the fine particles which are scattered from the scattering part to constitute the surface of the decorative layer is an amount which corresponds to a setting content regarding a tactile sensation of the decorative member and to a jetting amount of the fluid from the jetting part during the formation of the decorative layer.

2. The decorative member manufacturing apparatus according to claim 1,
wherein the jetting amount of the fluid from the jetting part during the formation of the decorative layer is an amount according to a reproduction color of the decorative layer,
the jetting part jets, toward the base material, a plurality of types of colored fluids having different colors from each other,
a jetting amount of the colored fluids is set for each type of the colored fluids, and
the amount of the fine particles which are scattered from the scattering part to constitute the surface of the decorative layer is an amount which corresponds to the setting content regarding the tactile sensation of the decorative member and to the jetting amount of the each type of the colored fluids.

3. The decorative member manufacturing apparatus according to claim 2,
wherein the jetting part jets a transparent fluid which is cured by receiving light to superpose the transparent fluid on the colored fluid which has landed on the base material,
the scattering part scatters the fine particles to adhere the fine particles to the transparent fluid superposed on the colored fluid,
the amount of the fine particles constituting the surface of the decorative layer is determined according to a jetting amount of the transparent fluid from the jetting part, and
the jetting amount of the transparent fluid from the jetting part is set according to the setting content regarding the tactile sensation of the decorative member and to the jetting amount of the colored fluid.

4. The decorative member manufacturing apparatus according to claim 3, further comprising:
a semi-curing part which semi-cures the transparent fluid by irradiating the transparent fluid superposed on the colored fluid with light,
wherein the scattering part scatters the fine particles to adhere the fine particles to the semi-cured transparent fluid.

5. The decorative member manufacturing apparatus according to claim 3,
wherein, in a case where the surface of the decorative layer is divided into a plurality of regions, each of the jetting amount of the colored fluid and the jetting amount of the transparent fluid is set for each of the regions.

6. The decorative member manufacturing apparatus according to claim 3, further comprising:
a reference information storage part that stores first reference information for determining a jetting amount of the colored fluid, which is required to reproduce the reproduction color of the decorative layer, from the reproduction color of the decorative layer, and second reference information for determining a jetting amount of the transparent fluid, which is required to adhere the fine particles in an amount for realizing the tactile sensation indicated by the setting content, from the setting content and the jetting amount of the colored fluid; and
a condition setting part that sets the jetting amount of the colored fluid based on the first reference information, and sets the jetting amount of the transparent fluid based on the second reference information.

7. The decorative member manufacturing apparatus according to claim 6,
wherein the first reference information is a conversion table for converting a gradation value of the reproduction color of the decorative layer into the jetting amount of the colored fluid, which is required to reproduce the reproduction color of the decorative layer, and
the second reference information is a conversion table for converting a value of a target tactile sensation indicated by the setting content and the jetting amount of the colored fluid into a jetting amount of the transparent fluid, which is required to adhere the fine particles in an amount for realizing the target tactile sensation.

8. The decorative member manufacturing apparatus according to claim 7,
wherein the target tactile sensation is a magnitude of friction on the surface of the decorative layer.

9. The decorative member manufacturing apparatus according to claim 8,
wherein the condition setting part sets the jetting amount of the transparent fluid according to a type of the base material used during the formation of the decorative layer.

10. The decorative member manufacturing apparatus according to claim 7,
wherein the reference information storage part stores a plurality of the second reference information,
the plurality of the second reference information respectively correspond to values of the target tactile sensation, which are different from each other, and
the condition setting part refers to second reference information which is selected based on the value of the target tactile sensation indicated by the setting content among the plurality of the second reference information stored in the reference information storage part.

11. The decorative member manufacturing apparatus according to claim 10,
wherein the condition setting part refers to second reference information associated with a value of the target tactile sensation, which is closest to the value of the target tactile sensation indicated by the setting content among the plurality of the second reference information stored in the reference information storage part.

12. The decorative member manufacturing apparatus according to claim 11,
wherein, in a case where the value of the target tactile sensation associated with each of the plurality of the second reference information stored in the reference information storage part is different from the value of the target tactile sensation indicated by the setting content, the condition setting part refers two second reference information satisfying the following requirements (1) and (2) among the plurality of the second reference information, and sets the jetting amount of the transparent fluid from the jetting part during the formation of the decorative layer according to a jetting amount derived from the two second reference information referred,
requirement (1): a value of the target tactile sensation associated with one of two second reference information is closest to the value of the target tactile sensation indicated by the setting content in a numerical range larger than the value of the target tactile sensation indicated by the setting content
requirement (2): a value of the target tactile sensation associated with the other of the two second reference information is closest to the value of the target tactile sensation indicated by the setting content in a numerical range smaller than the value of the target tactile sensation indicated by the setting content.

13. A method for manufacturing a decorative member having a decorative layer formed on a surface of a base material, the method comprising:
jetting a fluid from a jetting part toward the surface of the base material to form the decorative layer; and
scattering fine particles constituting a surface of the decorative layer from a scattering part toward the base material,
wherein an amount of the fine particles which are scattered from the scattering part to constitute the surface of the decorative layer is an amount which corresponds to a setting content regarding a tactile sensation of the decorative member and to a jetting amount of the fluid from the jetting part during the formation of the decorative layer.

14. The decorative member manufacturing apparatus according to claim 4,
wherein, in a case where the surface of the decorative layer is divided into a plurality of regions, each of the jetting amount of the colored fluid and the jetting amount of the transparent fluid is set for each of the regions.

15. The decorative member manufacturing apparatus according to claim 4, further comprising:
a reference information storage part that stores first reference information for determining a jetting amount of the colored fluid, which is required to reproduce the reproduction color of the decorative layer, from the reproduction color of the decorative layer, and second reference information for determining a jetting amount of the transparent fluid, which is required to adhere the fine particles in an amount for realizing the tactile sensation indicated by the setting content, from the setting content and the jetting amount of the colored fluid; and
a condition setting part that sets the jetting amount of the colored fluid based on the first reference information, and sets the jetting amount of the transparent fluid based on the second reference information.

16. The decorative member manufacturing apparatus according to claim 15,
wherein the first reference information is a conversion table for converting a gradation value of the reproduction color of the decorative layer into the jetting amount of the colored fluid, which is required to reproduce the reproduction color of the decorative layer, and
the second reference information is a conversion table for converting a value of a target tactile sensation indicated by the setting content and the jetting amount of the colored fluid into a jetting amount of the transparent fluid, which is required to adhere the fine particles in an amount for realizing the target tactile sensation.

17. The decorative member manufacturing apparatus according to claim 16,
wherein the target tactile sensation is a magnitude of friction on the surface of the decorative layer.

18. The decorative member manufacturing apparatus according to claim 17,
wherein the condition setting part sets the jetting amount of the transparent fluid according to a type of the base material used during the formation of the decorative layer.

19. The decorative member manufacturing apparatus according to claim 8,
wherein the reference information storage part stores a plurality of the second reference information,
the plurality of the second reference information respectively correspond to values of the target tactile sensation, which are different from each other, and
the condition setting part refers to second reference information which is selected based on the value of the target tactile sensation indicated by the setting content among the plurality of the second reference information stored in the reference information storage part.

20. The decorative member manufacturing apparatus according to claim 19,
wherein the condition setting part refers to second reference information associated with a value of the target tactile sensation, which is closest to the value of the target tactile sensation indicated by the setting content among the plurality of the second reference information stored in the reference information storage part.
